(19) United States
(12) Patent Application Publication
(10) Pub. No.: US 2020/0235581 A1
(43) Pub. Date: Jul. 23, 2020

(54) Parallel Method for Two Electrical Generators

(71) Applicants: Quincy Qing Wang, Wellington, FL (US); Nan An, Boca Raton, FL (US)

(72) Inventors: Quincy Qing Wang, Wellington, FL (US); Nan An, Boca Raton, FL (US)

(73) Assignee: Novelek Technology Inc., Wellington, FL (US)

(21) Appl. No.: 16/251,680

(22) Filed: Jan. 18, 2019

(51) Int. Cl. H02J 3/38; H02P 9/08

(52) U.S. Cl. CPC H02J 3/38; H02P 9/08

(57) ABSTRACT

The present invention provides a parallel method for two electrical generators, more particularly, a parallel method for controlling a Micro-turbine Generator (MTG) in parallel with a traditional Reciprocating Generator (RG). A parallel protection equipment is designed to connect with both the Micro-turbine Generator (MTG) and the traditional Reciprocating Generator (RG) in parallel operation during the Micro-turbine Generator (MTG) regular inspection and maintenance without the power shutoff under the safe condition. The parallel protection equipment comprises a plurality of power resistors, terminal blocks, a breaker, a 24V control relay and a bypass contactor. In addition, the present invention provides bypass contactor control through a monitoring signal contributed by the traditional Reciprocating Generator (RG) working in parallel or by a customer control panel.

### BACKGROUND OF THE INVENTION

Remote locations without electrical utility power lines need stand-alone generators to meet their electrical power needs. These locations include offshore oil rig platforms, small islands, remote villages etc. If power needs is less than 1000 kW, more and more projects in remote area find Micro-turbine Generator (MTG). It is an idea primary power source, capable of providing long-term electricity, continuously without interruption, 24 hours a day 7 days a week. This is because Micro-turbine Generator (MTG) only has one moving part inside, the turbine rotor. Contrarily, a traditional Reciprocating Generator (RG) has many moving parts inside, which cause high friction loss and need frequent engine oil change. Therefore, MTG has longer operation life, lower maintenance cost and higher efficiency than those of RG. However, RG is an idea backup power generator, because it has relatively low cost, mature stable technology, and well-known maintenance knowledge by customers.

When using a MTG as a stand-alone primary generator, and a RG as a backup generator, there is a strong market request to run these two generators together in parallel. That is, connecting output terminals of the MTG and RG together, two generators sending power to the same load simultaneously. This parallel running mode is required when customers start up the backup RG, shut down the MTG for periodical maintenance, and in the same time, strictly demand zero power interruption during MTG-to-RG transfer process. Also, after the satisfactory MTG maintenance work, the MTG-RG parallel running mode is required again to ensure zero power interruption when transferring power generation from RG back to MTG. If MTG and RG cannot run parallel, customer will have to turn off MTG output first, and then turn on RG output, or vice versa. There is always a power gap during generators transfer if parallel running equipment is not used between MTG and RG. For example, offshore oil rig platforms strictly require zero power interruption when switching platform power source from one generator to another. Market demands an invention to enable MTG parallel generating with RG. Without this invention, if zero power interruption is needed, MTG customers cannot use RG as the backup power source for their MTG. Although customers can use uninterrupted power supply (UPS) or the second MTG to backup primary source MTG and ensure zero power interruption, MTG customers will need to spend more money.

Traditional RG use a sync controller to enable parallel operation between RGs. But the sync controller is not capable to parallel RG and MTG. By the nature of technology, traditional RG sync controller is not accurate enough to satisfy parallel requirements from static power electronics converter based MTG, in aspects of controlling output frequency, phase angle and voltage magnitude. The present invention provides a parallel method for two electrical generators, more particularly, a parallel method for connecting the MTG and the traditional RG for parallel operation under a safe condition. The invention has been successfully implemented and tested. Equipment based on the present invention is currently satisfactorily running on BESA offshore oil platform in Malaysia, managed by Murphy Oil Company Malaysia branch.

U.S. Pat. No. 6,410,992B1 discloses a method of controlling a permanent magnet turbo-generator/motor includes providing a protected load connected in parallel with the turbo-generator/motor through a pulse width modulated inverter configured in a first operating mode to supply controlled current from the turbo-generator/motor to a utility electrical power source, and selectively connected to the utility electrical power source through an isolation device, monitoring the utility electrical power source, and automatically disconnecting the protected load from the utility electrical power source while reconfiguring the pulse width modulated inverter in a second operating mode to supply controlled voltage to the protected load when a fault is detected in the utility electrical power source.

U.S. Pat. No. 7,078,825B2 discloses a Micro-turbine engine that includes a compressor that is operable to provide a flow of compressed air. The compressed air flows through a recuperate where it is preheated before delivery to a combustor. The preheated compressed air mixes with a fuel and is combusted within the combustor to provide a flow of products of combustion. The flow of products of combustion passes through one or more turbines to drive the compressor and a synchronous generator. The synchronous generator is able to synchronize to a priority load, to the utility grid or to both depending on the mode of operation. A control system monitors various engine parameters as well as load and grid parameters to determine the desired mode of operation.

In the prior of the invention, the Micro-turbine engine system was mentioned that it has stand-alone and grid-parallel operating modes. Or so there is a method that the turbine generator/motor can be connected in parallel with another turbine generator/motor or the existing utility grid with a protected load. It is not considered that the MTG connects with the traditional RG in parallel operation, standing alone without power grid. There is a need to further improve the ability of the MTG in parallel with the traditional RG, therefore, it is desirable to design a durable parallel protection equipment with long lifetime for the MTG in parallel with the traditional RG. This parallel protection equipment would provide greater protection for the MTG in parallel with the traditional RG.

### SUMMARY OF THE INVENTION

For the above-described problem, the present invention provides a solution to the problem which a parallel protection equipment is designed to connect with both the MTG and the traditional RG. The parallel protection equipment comprises a plurality of power resistors, terminal blocks, a breaker, a 24V control relay and a bypass contactor. In various applications, MTG can be used to generate electricity independently for most of time. To operate efficiently, MTG works at a very high speed and temperature. The MTG is required to be inspected and maintained regularly. There is at least one backup traditional RG in the field installation. The traditional RG needs start to work to ensure that customer load will not lose power before MTG is shut off and inspected. Therefore the MTG and the traditional RG need to be connected together with the customer load at the same time. Without the invented parallel protection equipment, when the MTG and the RG are directly connected to run in parallel as stand-alone voltage source, their extremely small internal resistances are only resistances between these two power generators. The generated three phase output AC voltages from MTG and RG are not exactly the same, in aspects of voltage magnitude, voltage phase angle, and voltage frequency. Therefore, when voltage difference between two generators is applied on extremely small internal resistance of generators, electric current flow between two generators will be very high and exceed their safety values. The high current flow will cause MTG power converter damage and MTG shutoff, causing RG damage too. Based on above reasons, the invented parallel protection equipment is required to be installed permanently for MTG applications if the MTG is required to run in parallel with the traditional RG in stand-alone mode.

FIG. 1 shows a color photograph of the parallel protection equipment. In FIG. 2, the components of the parallel protection equipment are shown, the parallel protection equipment includes a plurality of power resistors, terminal blocks, a breaker, a 24V control relay and a bypass contactor. In FIG. 3, the schematic diagram shows the concept of the MTG and the traditional RG in parallel operation with the parallel protection equipment. For all applications, there is a customer control panel to monitor the RG status. When the RG output power is switched off, the control signal is read as one (1) from the customer control panel, the bypass contactor K₁ is closed based on this signal. The MTG is now supplying full current through contactor K₁ to the load. When the RG output power is switched on, the control signal is read as zero (0) from the customer control panel, the bypass contactor K₁ is disconnected based on this signal. When K₁ opens, the MTG only takes small current passing through a set of resistors and the breaker to the load, the major current requested by customer load will be transferred to the RG. Then, the MTG can be shut off for inspection and maintenance while the RG is taking major load. There is no power gap during this transfer operation. Maximum current flowing between two none-identical voltage sources, MTG and RG, is limited to a safe value by the set of resistors, thus the MTG and RG parallel operation is achieved successfully. In abnormal conditions, if the current passing through resistors exceeds the breaker's maximum limit value, the breaker will trip off and disconnect the MTG from the RG and the load. This is to prevent high current causing resistors overheat in abnormal conditions. FIG. 4 shows the complete circuit diagram of the parallel protection equipment designed for MTG and RG parallel operation. If the control signal of the customer panel is equal or less than 24V DC voltage, the bypass contactor will be controlled by the relay. Otherwise the control signal is required to be 230V AC, to directly control the bypass contactor coil.

This parallel protection equipment enables parallel operations between MTG and RG in various applications where zero power interruption is required during load transferring between MTG and RG.

### REFERENCE

1. U.S. Pat. No. 6,410,992B1, Aug. 23, 2000-Jun. 25, 2002. Capstone Turbine Corp. System and method for dual mode control of a turbogenerator/motor.
2. U.S. Pat. No. 7,078,825B2, Jun. 18, 2002-Jul. 18, 2006. Ingersoll-Rand Energy Systems Corp. Micro-turbine engine system having stand-alone and grid-parallel operating modes.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a color photograph of the parallel protection equipment.

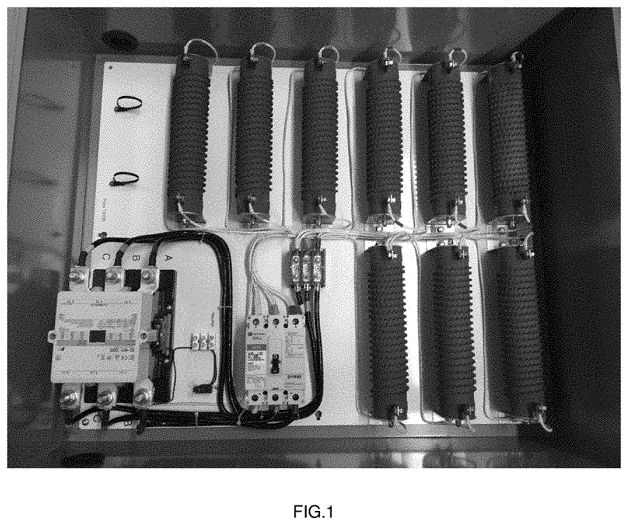

FIG. 2 shows a schematic view of components of the parallel protection equipment.

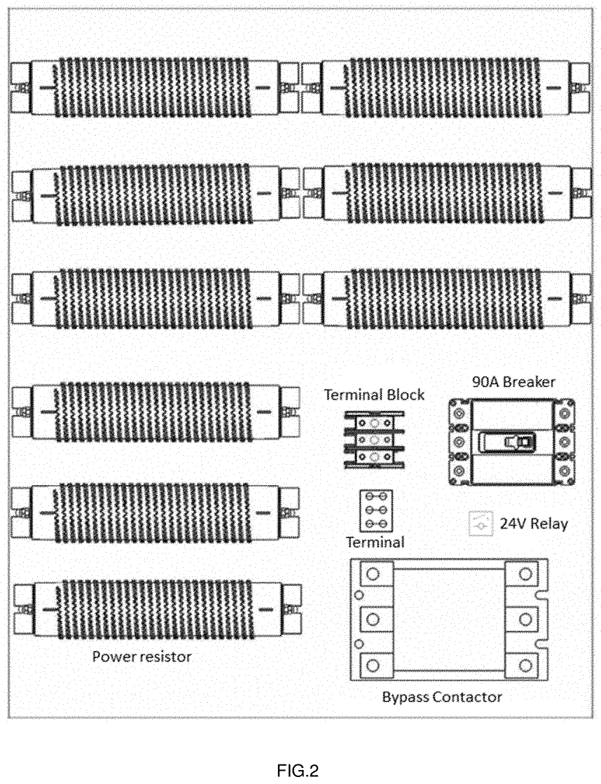

FIG. 3 shows a single-line schematic view of concept of Micro-turbine generator and traditional reciprocating generator in parallel operation with the parallel protection equipment.

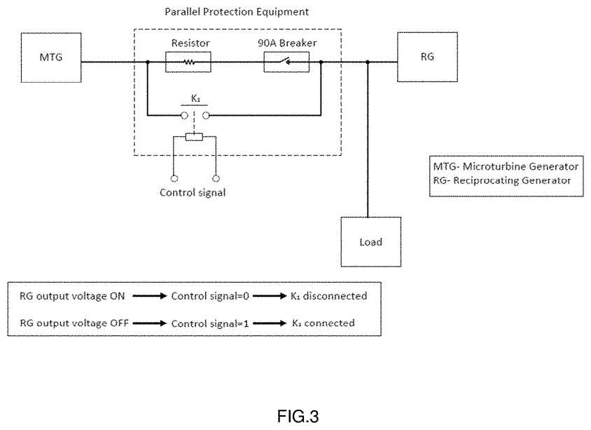

FIG. 4 shows a schematic view of circuit diagram of the parallel protection equipment.

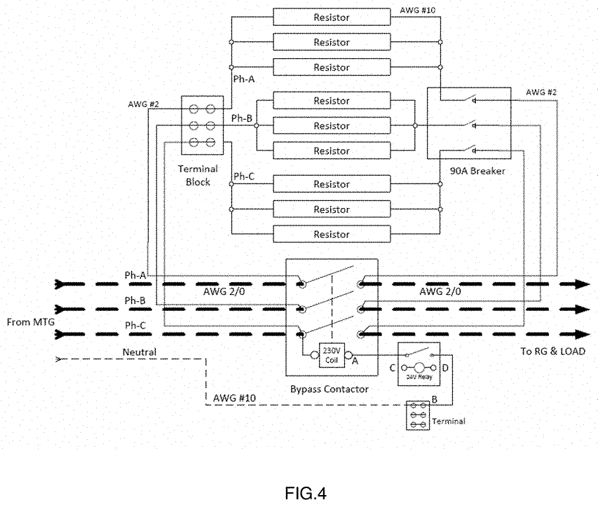

What is claimed:

1. A method of connecting a Micro-turbine generator and a traditional reciprocating generator in parallel with a parallel protection equipment comprising:
(1) providing a plurality of resistors in the parallel protection equipment connected between the Micro-turbine generator and the traditional reciprocating generator to limit current flow between two generators;
(2) controlling the main current flow from the Micro-turbine generator to the load with a bypass contactor;
(3) limiting current flow passing through the plurality of resistors to a safe value by a protective breaker.

2. The method of claim 1 can also be applied to any two generators in parallel operation, if the current flow between these two generators is found larger than their maximum allowable value.
